(19) United States
(12) Patent Application Publication
(10) Pub. No.: US 2013/0044114 A1
(43) Pub. Date: Feb. 21, 2013

(54) Visual Representation of Data According to an Abstraction Hierarchy

(71) Applicants: Edwin R. Burtner, Richland, WA (US); Shawn J. Bohn, Richland, WA (US); Arthur H. Bleeker, West Richland, WA (US); Luke J. Gosink, Richland, WA (US); David S. Gillen, Kennewick, WA (US)

(72) Inventors: Edwin R. Burtner, Richland, WA (US); Shawn J. Bohn, Richland, WA (US); Arthur H. Bleeker, West Richland, WA (US); Luke J. Gosink, Richland, WA (US); David S. Gillen, Kennewick, WA (US)

(73) Assignee: BATTELLE MEMORIAL INSTITUTE, Richland, WA (US)

(21) Appl. No.: 13/211,587

(22) Filed: Aug. 17, 2011

(51) Int. Cl. G06T 11/20

(52) U.S. Cl. 345/442

(57) ABSTRACT

Visual representations having visual nodes that can each show up to two levels of an abstraction hierarchy of data, extracted elements of the data, and/or categories thereof, with the optional ability to explode the data, the extracted elements, and/or the categories into additional visual nodes provide capability for deeper composition exploration. Relationships among the data, the extracted elements, and/or the categories can be represented via lines within and across visual nodes. The visual representation can provide an user with awareness of different attributes of the data, the extracted elements, and/or the categories in context even for large, complex corpora of data. The representations of the data, the extracted elements, and/or the categories in the visual representation can be sorted, can depict relative size or quantity across various attributes, and can provide insight into relationships based on metadata and/or content.

### STATEMENT REGARDING FEDERALLY SPONSORED RESEARCH OR DEVELOPMENT

This invention was made with Government support under Contract DE-AC0576RLO1830 awarded by the U.S. Department of Energy. The Government has certain rights in the invention.

### BACKGROUND

The proliferation of multimedia data is as great as it ever has been. Consumer electronic markets have enabled individuals to record and transmit images or video with cell phones, and even the simple point and shoot camera not only date stamps, but can also geo-code where the photo was taken. The massive amount of information generated through tweets, text messages, instant messages, and email from work, home, and on our mobile devices is another example of the data generated in and about the world around us. Further still, the commercial sectors are publishing information that individuals receive via podcast, internet streaming broadcasts, radio, cable, satellite, etc. For those who must analyze and/or synthesize information from one or more of such sources, the task of handling and comprehending these large volumes of data can be overwhelming. In order to comprehend and articulate the big picture, it is necessary to construct and represent context, content, and relationships from multimedia information sources. However, a broad understanding of content and type is difficult in large collections of data, specifically in multimedia. Multimedia encompasses complex documents with other nested multimedia content. Multimedia is extremely diverse in application. Large collections of data containing multiple types of data are hard for users, which can include, for example, analysts, to summarize and understand, much less digest. Multimedia content is difficult to search through for specific content. Information fusion is a very difficult and complex problem to solve. Context is just as important as content and search potentially removes context. Therefore, a need exists for systems and methods to visually represent large amounts of data in a manner that communicates context, content, and relationships among the data.

### SUMMARY

Embodiments of the present invention relate to visual representations having visual nodes that can each show up to two levels of an abstraction hierarchy of data, extracted elements of the data, and/or categories thereof, with the optional ability to explode the data, the extracted elements, and/or the categories into additional visual nodes for deeper composition exploration. Relationships among the data, the extracted elements, and/or the categories can be represented via lines within and across visual nodes. The visual representation can provide an user with awareness of different attributes of the data, the extracted elements, and/or the categories in context even for large, complex corpora of data comprising multimedia. The representations of the data, the extracted elements, and/or the categories in the visual representation can be sorted, can depict relative size or quantity across various attributes, and can provide insight into relationships based on metadata and/or content.

In one embodiment, a system comprises memory circuitry to store a corpus of data and processing circuitry to generate on a display device a visual representation of the data, elements extracted from the data, and/or categories of the data arranged according to an abstraction hierarchy defined according to an abstraction basis. The data, the extracted elements, and/or the categories can be referred to collectively or in parts as “visualization content.” The visual representation comprises at least one visual node having an outer circle and an inner circle. The outer circle represents a parent level of the abstraction hierarchy and has arcs representing nodes in a parent level of the abstraction hierarchy. The inner circle represents a child level of the abstraction hierarchy and has arcs representing nodes in a child level of the abstraction hierarchy. The inner-circle arcs that are encompassed by a sector defined in part by an outer-circle arc represents child abstraction hierarchy nodes abstracted under a parent abstraction hierarchy node represented by the outer-circle arc.

As used herein, an arc refers a segment of the circumference of a circle. A sector refers to the portion of a circle enclosed by two radii and an arc. Accordingly, an arc in the outer circle of one visual node can define, in part, a sector that encompasses one or more arcs in the inner circle. The inner-circle arcs encompassed within the sector are child nodes to the parent node, which is represented by the outer-circle arc defining the sector, in the abstraction hierarchy.

Abstraction, as used herein, can refer to a process by which higher concepts are derived from the usage and classification of literal concepts, first principles, or other methods. An abstraction is a concept that acts as a super-categorical noun for all subordinate concepts, and connects any related concepts as a group, field, or category. Abstractions can be formed by reducing the information content or concept or an observable phenomenon, typically to retain only information which is relevant for a particular purpose. The criteria that determines the information content, concepts, or observable phenomena, to retain and/or discard is referred to as the abstraction basis.

An abstraction hierarchy, as used herein, can refer to a hierarchy of abstractions defined in part according to an abstraction basis. The lowest level of the abstraction hierarchy contains the abstraction hierarchy nodes having the lowest abstraction, or no abstraction at all. Each higher level in the abstraction hierarchy further categorizes and/or abstracts the abstraction hierarchy nodes below it. For example, an abstraction hierarchy related to video files can, at the highest level, have movies as nodes. In the next lower level, the nodes can represent the movies according to genre. The next lower level can have nodes representing actors/actresses starring in the movies. The next lower level can have nodes representing titles of movies. The next lower level can have nodes representing scenes from a movie starring a particular actor. At the lowest level of the abstraction hierarchy, the nodes can represent frames from the scenes of the movies. An alternative abstraction basis for the example above can be video file type (e.g., .mov, .avi, .flv, .mp4, etc.).

The abstraction hierarchy is an arrangement of the visualization content. The data can comprise video, audio, images, text, or combinations thereof. However, the data are not necessarily the most subordinate (i.e., least abstracted) objects in the hierarchy. In some instances, aspects of the data can be arranged into one or more subordinate levels relative to the level of the data themselves. In the example above, the data can refer to the video files from which the titles, actors, and frames originated. The video files are the data contained in the corpora. However, the least abstracted objects in the hierarchy can be individual frames extracted from the video files. The arrangement of objects, which can include the data, the extracted elements, and/or the categories in the hierarchy is determined, at least in part, by the abstraction basis.

Extracted elements of the data from the corpora can comprise metadata, portions of the data, and/or information related to or inferred from the data. For example, extracted metadata from video data can include, but are not limited to, video duration, title, geo-location, tags, date of creation, persons or objects present in the video, and video description. Portions of video data can include, but are not limited to, clips, frames, and isolated audio. Information related to or inferred from the data can be obtained from information analytics technology designed to generate such information using, for example, an ontology and/or artificial intelligence. One example of information related to or inferred from data is a recommendation of additional products based on existing products, which recommendations are provided by an automated service (e.g., Pandora, Apple Genius Recommendations, Amazon Recommendations, etc.)

The abstraction basis can define the manner and the categories by which the abstraction hierarchy is arranged. The abstraction basis can be provided, at least in part, via an input device through which a user inputs abstraction hierarchy definitions. In addition, or alternatively, the abstraction basis can comprise at least one abstraction hierarchy rule stored on memory circuitry. Using the abstraction hierarchy rules, the system can arrange data elements in an abstraction hierarchy in an automated fashion. Exemplary abstraction bases for multimedia data can include, but are not limited to, file type, content type, genre, title, author/creator, location, and data attributes. The abstraction bases between different visual nodes and/or between an inner and outer circle of a single visual node can be different. In one sense, each level in the abstraction hierarchy can be viewed as a pivot in a data cube. Neither the abstraction basis nor the visualized content is limited to multimedia data types. For example, the abstraction basis and/or the visualized content could include cyber data or other data modalities.

In preferred embodiments, the visual representation further comprises a link between a first visual node and a second visual node. The outer circle arcs in the second visual node correspond to inner-circle arcs within a sector of the first visual node. In one sense, the second visual node can be viewed as an expansion of an inner circle arc. The second arc provides a means of further navigating the abstraction hierarchy through the visual representation. In one instance, the two visual nodes depict three levels of the abstraction hierarchy (e.g., parent, child, and grandchild).

However, in some embodiments, the abstraction basis in one visual node differs from that in another visual node. In other words, in visualizing the second visual node, a pivot can occur by which the data elements abstracted and categorized in the first visual node are re-arranged to be abstracted and categorized differently in the second visual node. The re-arrangement occurs according to the abstraction basis of the second visual node, which differs from that of the first visual node. Furthermore, the abstraction basis in the outer circle can differ from the abstraction basis of the inner circle of a single visual node.

Embodiments of the present invention can further comprise at least one chord connecting two inner-circle arcs representing two particular abstraction hierarchy nodes, the chord representing a relationship between the two particular abstraction hierarchy nodes.

In some embodiments, the link between two visual nodes further comprises lines representing relationships between arcs in the inner circle of the first visual node and arcs in the inner circle of the second visual node. The lines can be maintained between visual nodes regardless of whether the abstraction basis of the visual nodes are the same or are different.

The relationship can be defined by pre-determined criteria. Exemplary relationships can include, but are not limited to, any measurement in which the various content types can be evaluated against. For example, image-to-image relationships can be computed based on a variety of computer vision techniques that work at the visual similarity level. Other more sophisticated techniques incorporate more semantic information so relationships can be extended to incorporate cross modality relationships, such as image-to-text. Other computer vision relationships could be based on measures of color, texture or shape to name a few. When dealing with other modalities, text relationships can be defined in terms of themes, sentiment or other text extraction measures to define a text-to-text relationship. There are essentially two types of measures, those that are continuous and those that are binary. The continuous relationships allow the user to understand the strength of the relationship, whereas the binary relationship is it either exists or not.

Another aspect of the present invention includes methods of displaying on a display device a visual representation of data stored on memory circuitry, elements extracted from the data, and categories of the data. The visual representation is arranged according to an abstraction hierarchy defined according to an abstraction basis. One embodiment of the method comprises the steps of generating at least one visual node having an outer circle and an inner circle, representing a parent level of the abstraction hierarchy by the outer circle and representing abstraction hierarchy nodes in the parent level by arcs in the outer circle. The present embodiment further comprises representing a child level of the abstraction hierarchy by the inner circle and representing abstraction hierarchy nodes in the child level by arcs in the inner circle. Finally, the embodiment comprises encompassing inner-circle arcs by a sector defined in part by an outer-circle arc, the inner-circle arcs encompassed by the sector represent child abstraction hierarchy nodes abstracted under a parent abstraction hierarchy node represented by the outer-circle arc.

In preferred embodiments, the method can comprise connecting two inner-circle arcs representing two particular abstraction hierarchy nodes with a chord. The chord can represent the relationship between the two particular abstraction hierarchy nodes and the relationship can be defined by pre-determined criteria.

The method can further comprise defining the abstraction basis at least in part according to abstraction hierarchy definitions provided by a user through an input device. Alternatively, or in addition, the abstraction basis can be defined, at least in part, by at least one abstraction hierarchy rule stored on memory circuitry. In such an instance, the arrangement of information can occur in an automated manner based on the pre-determined rules of the abstraction basis. As described elsewhere herein, the abstraction bases can differ between visual nodes and even between the inner and outer circles of a single visual node.

Preferably, the method comprises linking a first visual node and a second visual node such that the outer circle arcs in the second visual node correspond to inner-circle arcs within a sector of the first visual node. The linking can further comprise generating lines representing relationships between arcs in the inner circle of the first visual node and arcs in the inner circle of the second visual node.

The purpose of the foregoing abstract is to enable the United States Patent and Trademark Office and the public generally, especially the scientists, engineers, and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

Various advantages and novel features of the present invention are described herein and will become further readily apparent to those skilled in this art from the following detailed description. In the preceding and following descriptions, the various embodiments, including the preferred embodiments, have been shown and described. Included herein is a description of the best mode contemplated for carrying out the invention. As will be realized, the invention is capable of modification in various respects without departing from the invention. Accordingly, the drawings and description of the preferred embodiments set forth hereafter are to be regarded as illustrative in nature, and not as restrictive.

### DESCRIPTION OF DRAWINGS

Embodiments of the invention are described below with reference to the following accompanying drawings.

FIG. 1 is a diagram depicting a visual node according to embodiments of the present invention.

FIG. 2 is a diagram depicting an exemplary color scheme for a visual node.

FIGS. 3a and 3b are diagrams depicting labels applied to aspects of a visual representation according to embodiments of the present invention.

FIG. 4 is a diagram depicting relationship lines within and between visual nodes according to embodiments of the present invention.

FIG. 5 is a diagram illustrating one embodiment of the present invention having a plurality of visual nodes.

FIG. 6 contains diagrams depicting the formation of a child node from a parent visual node.

FIG. 7 is a diagram depicting one example of differentiating visual nodes one from another.

FIGS. 8a-8d contains diagrams illustrating the arrangement of a plurality of visual nodes.

FIGS. 9a-9d contains diagrams illustrating selections of various aspects and objects in a visual representation according to embodiments of the present invention.

FIG. 10 is a diagram depicting one example of a custom selection tool according to embodiments of the present invention.

### DETAILED DESCRIPTION

The following description includes the preferred best mode of one embodiment of the present invention. It will be clear from this description of the invention that the invention is not limited to these illustrated embodiments but that the invention also includes a variety of modifications and embodiments thereto. Therefore the present description should be seen as illustrative and not limiting. While the invention is susceptible of various modifications and alternative constructions, it should be understood, that there is no intention to limit the invention to the specific form disclosed, but, on the contrary, the invention is to cover all modifications, alternative constructions, and equivalents falling within the spirit and scope of the invention as defined in the claims.

Embodiments of the present invention provide an approach to explore in a visual representation the relationships between objects arranged in the abstraction hierarchy. The relationships between parent and child objects are depicted in the visual representation through the outer and inner circles, wherein the outer circle is the parent of the inner circle. Likewise, a sibling or peer relationship in the abstraction hierarchy is conveyed in the visual representation via the adjacent arcs within the same circle in a visual node. The “similarity” relationships between elements are displayed through the chord lines within a visual node and through lines between visual nodes.

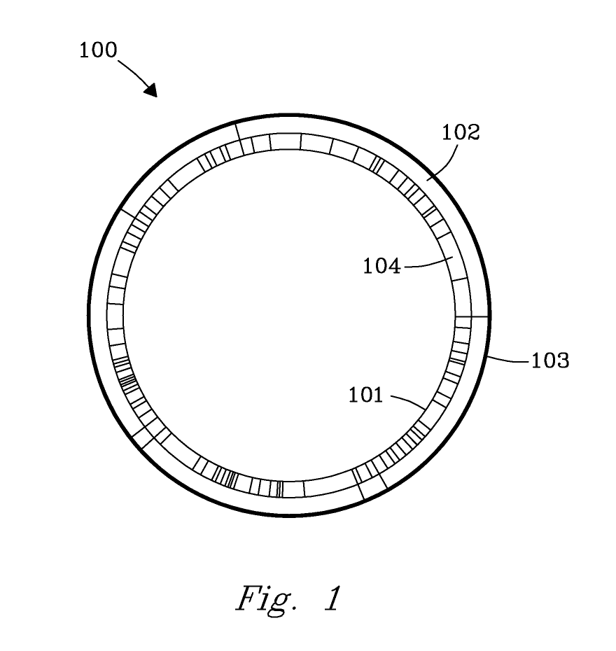

FIGS. 1-10 show a variety of aspects and embodiments of the present invention. Referring first to FIG. 1, a visual node 100 is depicted having an outer circle 103, an inner circle 101, outer-circle arcs 102, and inner-circle arcs 104. Each arc of an outer or inner circle represents at least one piece of visualized content according to the abstraction hierarchy. If an arc represents a category grouping, selecting the arc in the visualization will result in selecting the actual visualized content contained in the category grouping. If an arc represents an object at an atomic level (i.e., can not be further categorized or abstracted), then selecting the arc will result in selecting a single piece of visualized content (e.g., a data file or portion of the data file).

Each visual node's inner and outer circles are segmented into arcs in order to represent different abstractions and category groupings of the visualized content according to an abstraction basis. The coarsest groupings will be contained within the outer circle. Relatively finer groupings are contained within inner circles. For example, the outer circle can be segmented by file type: video, image, text document, compound document, audio, etc. The inner circle of the visual node can depict the groupings to the next level of granularity. For example, the audio arc of the outer circle may be further refined into smaller arcs within the inner circle by audio type (mp3, way, wma, mp4, raw, etc.). If a child visual node is pulled out, as is described elsewhere herein, the initial visual node becomes a parent node and the pattern of increasing segment granularity continues until the data can no longer be partitioned into smaller groupings (i.e., no further abstraction will occur).

Similar to a pie chart, the size of an arc can be determined by the percentage of visualized content represented by that arc compared to the total amount of visualized content. To illustrate, in the example above, if 50% of the visualized content is video related, an arc's outer circle can have an arc that occupies 50% of the outer circle circumference.

In some embodiments, the smallest size of an arc can be limited to ensure visibility. For example, according to Fitt's Law, the smaller a target, the harder it is to select on a display device. An arc that represents a very small percentage of the total visualized content may be too small to be seen in a visual node. For example, if an arc is determined to represent 0.05% of the content, it is likely that this will result in a nearly invisible segment of an outer or inner circle. In such an instance, the size of an arc, which is less than a minimum threshold, can be recalculated and enlarged. Alternatively, the size of the arc can be augmented in order to ensure that it is both visible and selectable by an input device.

Preferably, the minimum threshold for an arc is less than 5 pixels in width or height. If one or more arcs are below the minimum threshold and are too small to see and/or select, then in one particular embodiment, the small arcs can be grouped into a larger arc and given an appropriate label, such as “more.” This will allow the smaller arcs to be represented in the visual node while allowing the user to optionally expand the “more” arc into a daughter visual node for additional analysis. In one example, the “more” arc can be generated by first determining all other arcs which need to be designated as “too small.” If the number of inner-circle arcs which qualify for the “too small” category exceed 50% of the outer-circle arc's area, then these small inner-circle arcs can be combined into one arc and given an appropriate title or label such as “More.” On hovering with a mouse pointer, the first N categories can be listed. If there are more than N categories, an “Expand to see more . . . ” hyperlink can be added to the flyover, which will automatically create a child visual node based on the “More” arc. If the number of inner-circle arcs that qualify as being “too small” category is <50% of the outer-circle arc's area AND there is at least one other inner-circle arc that is “too small,” the inner-circle arcs that are too small can reclaim pixels from other arcs. For example, each arc that is too small can claim at least some pixels from the largest arcs, taking a proportional amount from each. If there are no other arcs which are “too small,” at least some pixels can be claimed from the largest arcs, taking a proportional amount from each.

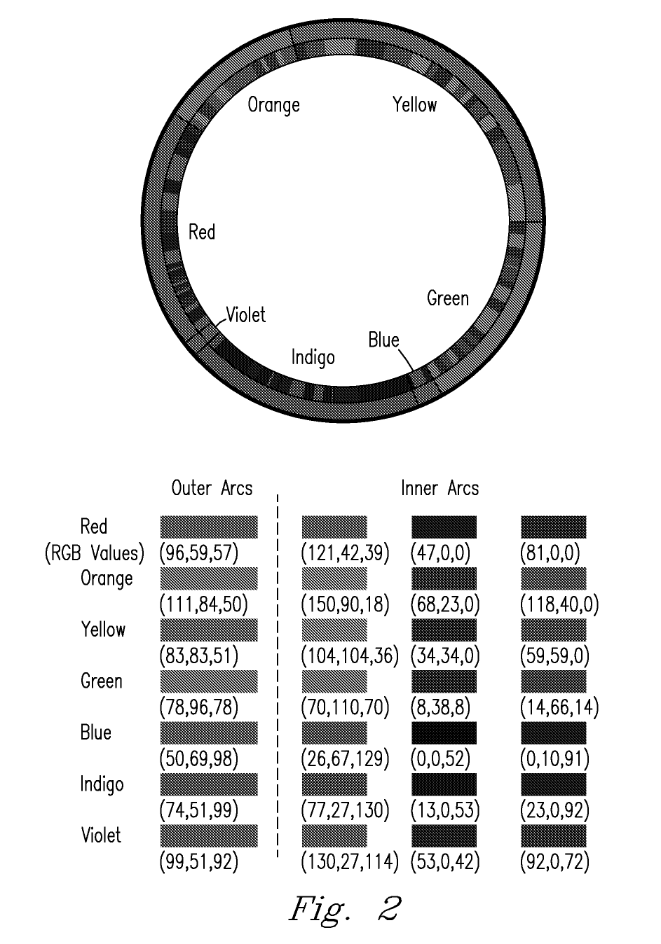

Embodiments of the present invention differ from traditional radial diagrams at least in that arcs within visual nodes can be explored in additional visual nodes rather than having an overwhelming number of inner circles, categories, and different colored sections within a single visual node. The user can utilize an input device to drag out one or more arcs from one visual node, which will expand those arcs in a connected child visual node. Like its parent visual node, the child visual node will have two rings. Preferably, the outer circle of the child visual node will represent at least a portion of the inner circle of the parent visual node. In the child visual node, the sections can be colored in different hues. And, like its parent visual node, the inner circle can represent sections displayed in a deepened hue. One specific example of a color scheme for visual nodes is depicted in FIG. 2.

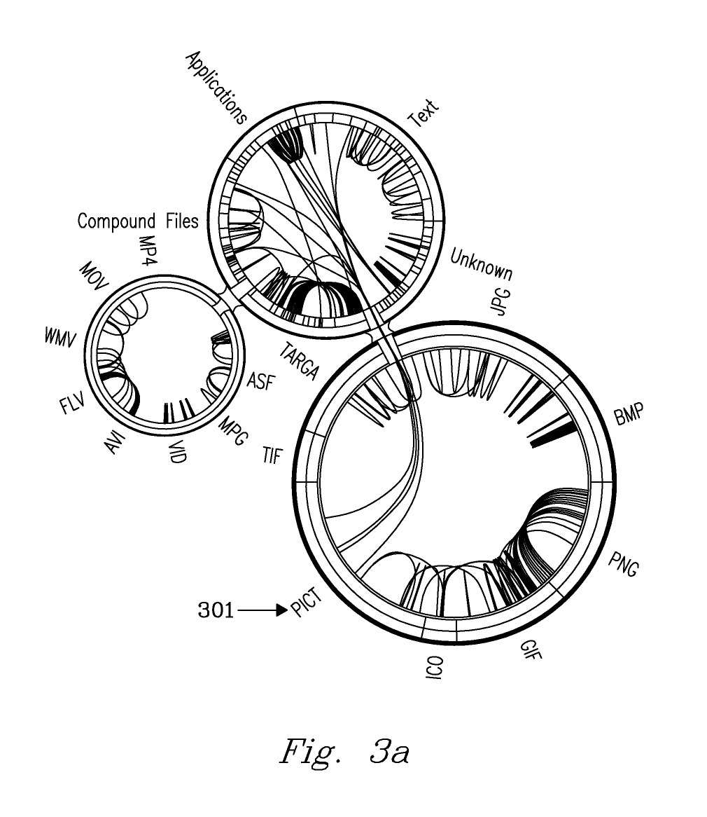

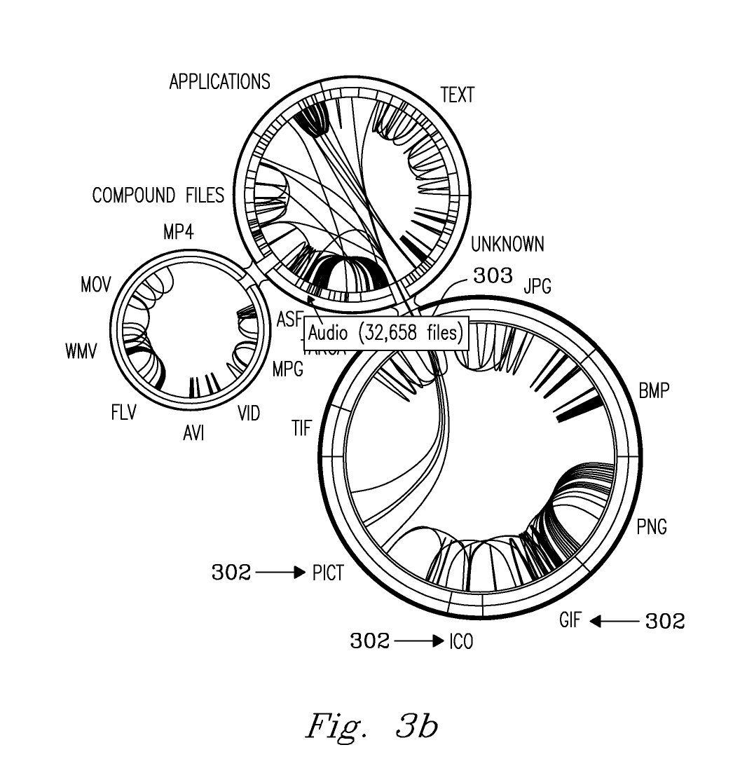

In the embodiments depicted by FIGS. 3a and 3b, the visual representation further comprises labels. The labels can be toggled and can differ in size and/or color depending on visual node activity. Referring to FIG. 3a, the labels for each segment can be laid out in a fan formation across the entirety of the arc. The labels 301 will be oriented in all degrees around the arc, but the text is be oriented for readability within each label. In other words, the labels can be positioned from top to bottom relative to the visual node, but the text will be positioned horizontally within the label. If there are labels on the bottom-right of the visual node, the text will appear to be resting on its right side. Likewise, if there are labels on the bottom-left of the visual node, the text will be appear to be resting on its left side. This pattern of positioning the text within the labels continues around the arc.

Alternatively, referring to FIG. 3b, the labels 302 can be oriented horizontally for proper readability and a physics engine can be allowed to adjust for minimal label collisions. Exemplary label collision rules for the physics engine can include, but are not limited to the following.
Never overlap or collide labels inside the same visual node
Visual nodes that are too small should collapse into a label marked as “more . . . ” as described elsewere herein.
Labels are flexible enough to make room for each other using the same physics rules applied to the nodes. When a label is moved too far away from its arc segment then we either draw a line to that segment or don't display the label.
Labels that cannot display because of space constraints should appear as mouse over tool tips 303. (See tool tips below)
   Alternatively, a user can manually click, or touch, and drag a visual node and/or arc to a different position while staying within the limitations of embodiments of the present invention.

The size of the text within the label can be determined by the visual node's proximity to the last selected or active visual node. The active visual node (i.e., the one that is selected and/or highlighted) will have the largest font sizes. The connected visual nodes will have the second largest font size, followed by its connected nodes and so on. In a particular example, the active visual node can have a font size of 24 pt and RGB colors of 153, 153, 153 respectively. The parent visual node to the active node can have a font size of 18 pt and RGB colors of 92, 92, 92 respectively. An inactive visual node can have a font size of 12 pt and RGB colors of 0, 0, 0 respectively.

By default, all labels of the different arcs can be shown. As relationships, arcs and visual nodes are selected, visible labels can be toggled on an off. Likewise, labels can globally be explicitly toggled on or off through the action of a user. Preferably, once a relationship is selected and/or highlighted, only the arc labels for that relationship will be shown. Likewise, when an arc is selected, only those labels related to the arc (e.g., through relationship lines OR parent-child relationships) will be shown. All non-related labels will be toggled off. Once all the relationship paths (and/or arc) are deselected, the labels for all arcs can be toggled back on. Furthermore, when a child visual node is “born,” that is when it is pulled away from its parent visual node, all the labels of that child visual node can be toggled on and all other labels associated with other arcs can be toggled off. In this way labels can be made to only be visible for active and parent visual nodes.

In preferred embodiments, all visual nodes and arcs have tooltip functionality. This can be for managing label collision and long label truncating. Tooltips refers to a graphical user interface element in which a “hover box” 303 containing information appears when a cursor hovers over an item without clicking the item. For example, the tooltip can provide the full text of a truncated label. The tooltip can also list the labels of multiple arcs, which were designated as “too small,” aggregated under a single arc labeled “more.”

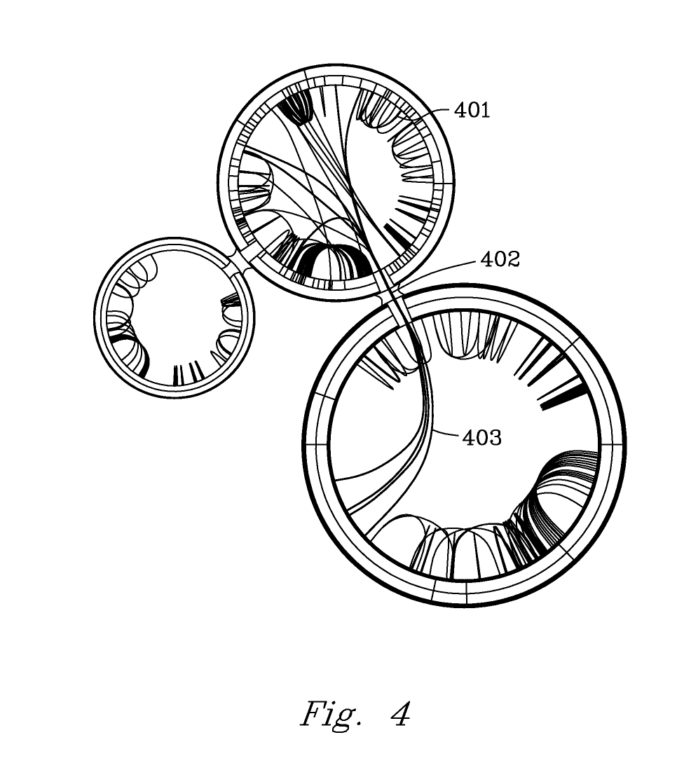

Referring to FIG. 4, similarity relationships can be represented by lines between 402 and within 401 visual nodes. In one embodiment, the lines can be curved and bundled when appropriate to prevent line proliferation across and within the visual nodes. The curved relationship lines allow for a level of organization for those related segments that are close within proximity. The relationship lines between arcs can have a default color and be colored differently when the relationship path or a connected arc is selected and/or highlighted 403.

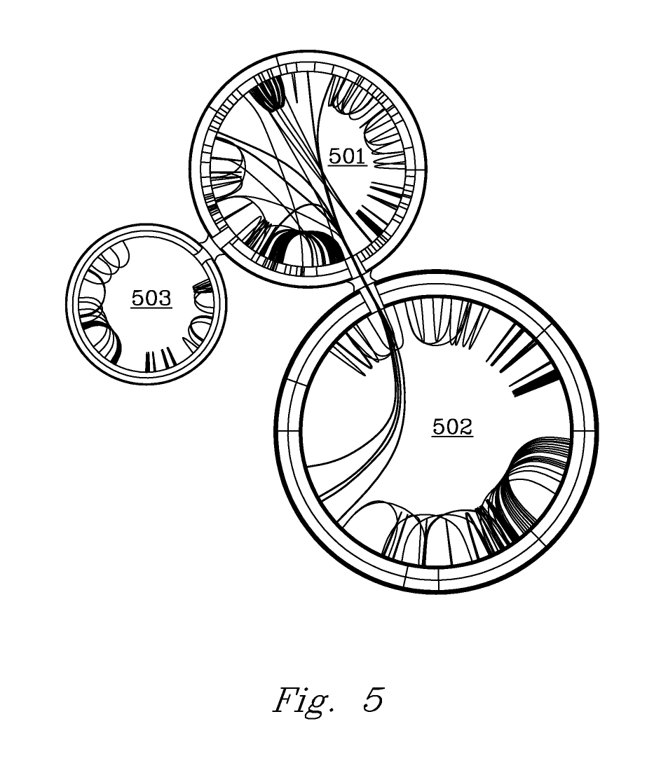

Referring to FIG. 5, a plurality of visual nodes can exist in visual representations of the present invention. Given a visual node 501 with arcs in an inner circle, an additional child visual node 502 can be birthed to represent an arc from the parent visual node 501. Yet another node 503 can be linked to the parent node 501 as a sibling to node 502 or as a parent to node 501.

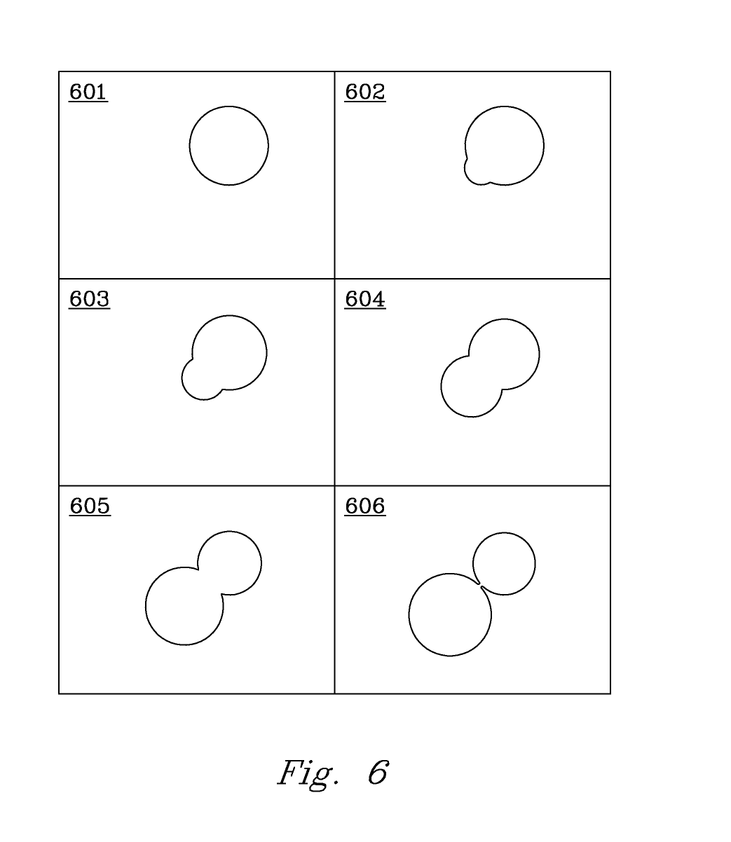

To create a child visual node, a user through an input device can click-hold an arc in the parent visual node and pull it away from the inner circle or outer circle. For touch screen devices, a user can touch and drag arcs. Referring to FIG. 6, as the arc is pulled away from the parent visual node, the child node will start to take shape & gracefully animate to a full-sized visual node 601-604. This full-sized node will contain an outer circle segmented into arcs, which in some embodiments will be the same as the arcs in the visual node from which it was birthed. The inner circle of the child visual node can comprise arcs subsumed by the arcs of the outer circle. Preferably, the creation is animated in such a way to convey several concepts. For example, the child node can be animated to show that the node is being grown from a segment of the parent node. Furthermore, the child node can gradually become in focus 605 (i.e., increase in real estate and/or color) relative to the parent. Further still, as the child node pulls away, a link 606 connects the parent and the child node.

In one example, if an arc containing and labeled “Images” was pulled away from a visual node, then a child visual node would be created and would be called “Images.” The outer circle of the child visual node could comprise arcs arranged as image types, and could have an inner circle with additional arcs arranged as actual images. The present example assumes that the abstraction basis has not changed between the parent and child visual nodes.

If the abstraction basis changes when the child visual node is birthed, then the arrangement of arcs can also change. For example,

Exemplary portions of abstraction hierarchies that are visualized according to embodiments of the present invention can include, but are not limited to the following instances for video, document, and image and text, wherein each bullet below represents a visual node.

VIDEO

◯ Type

▪ Mime type

 Alphabetical

◯ File name

▪ Shot

DOCUMENTS

◯ Type

▪ Mimie type

 Alphabetical

◯ Document name

▪ Type (start back at top)

IMAGE AND TEXT

◯ Type

▪ Mime type

 Alphabetical

◯ File name

Child visual nodes can be pulled out from either the inner circle or the outer circle of a parent visual node. In the case of the inner circle, the child visual node would be represented as a subsection of the outer—in effect splitting the outer circle. Behavior would be very similar to custom selection, which is described in greater detail elsewhere herein. Preferably, a node can be closed by dragging it back into its source or at the very least by right clicking an input device to get a context menu for closing the node. When a visual node is birthed, it must not collide with existing visual nodes. Rather, it may shift the visualization for the optimal layout of nodes. In instances where there is no further node to expand and the user has browsed to the end of a portion of the abstraction hierarchy, the child visual node will not display an inner circle.

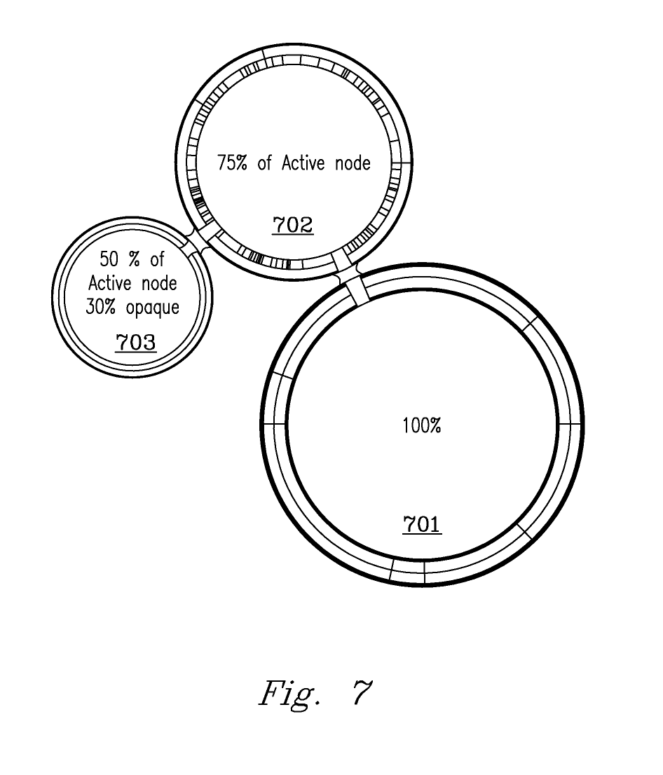

In some embodiments, the size of a visual node is determined by its relationship with the active node. An active node refers to the visual node that was last selected, highlighted, or pulled out. Preferably, the active visual nodes should be given the largest amount of spcae of all the visual nodes. For example, as depicted in FIG. 7, the active visual node 70.1 can be largest in size at 100%. The parent node 702 of the active node can be displayed at 75% while all other nodes 703 can be displayed at 50%. Furthermore, all of the non-active nodes 703 can be displayed as 30% opaque to further distinguish the active node 701. As new visual nodes are being and born and explored, nodes furthest from the new node can grow smaller. Preferably, a node should have a minimum size defined so that it is selectable. In a particular example, the minimum size of a node should be 150×150 px.

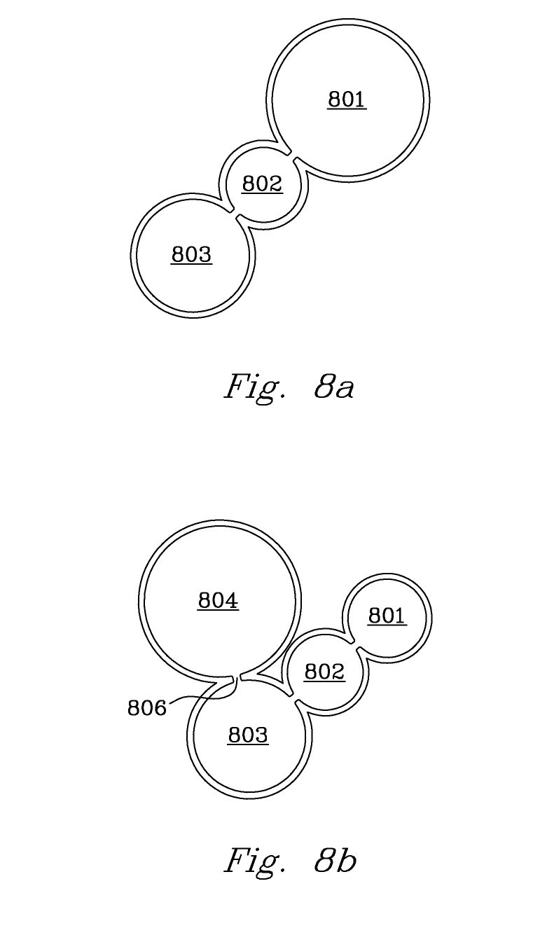

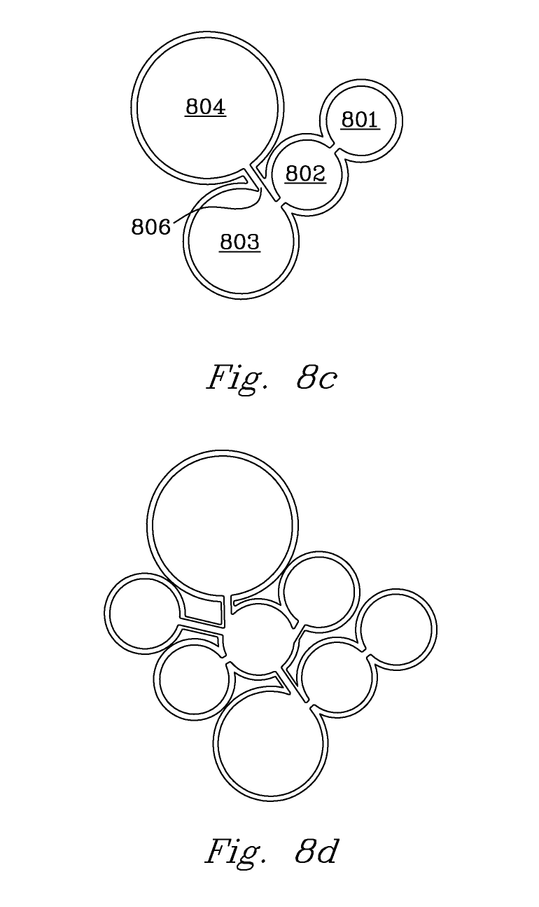

Referring to FIG. 8a through 8d, as child visual nodes are created, the nodes can be positioned and repositioned as similar to fractal growth. In FIG. 8a, Type 803 is the initial node. Image 802 is a sub-node (i.e., child) of Type, and PNG 801 is a sub-node (i.e., child) of image. Notice that PNG is the largest node since it is selected. Referring to FIG. 8b, the Text node 804 is pulled out of the Type node 803. Comparing links 806 and 807 in FIGS. 8b and 8c, respectively, the node links between the “Type” node and “Text” node can be repositioned to more clearly bundle the connections. FIG. 8d depicts one example of fractal-like growth of additional visual nodes as they are created.

In one embodiment, each visual node can be arranged individually and/or have a different abstraction basis. For example, a parent node may be arranged by data type while it's child node may be arranged by metadata such as author regardless of data type. Allowing each node to be arranged independently affords more freedom for exploration. Eventually, as child nodes are born, each node may reach an atomic level for certain arrange-by categories. For example, once a PNG type is chosen for image, it can no longer be further decomposed by type. Only options that are relevant (i.e., not “data type” in the previously mentioned example) will be presented to users.

Once a visual node is chosen to be arranged differently, the node's arcs will be redrawn to reflect the new arrange-by option. In addition, if the visual node being updated has any child nodes, all child nodes will disappear since the parent arcs from which they were born will no longer persist.

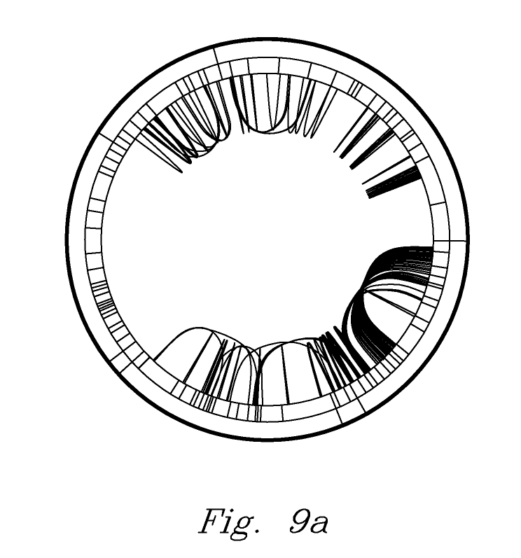

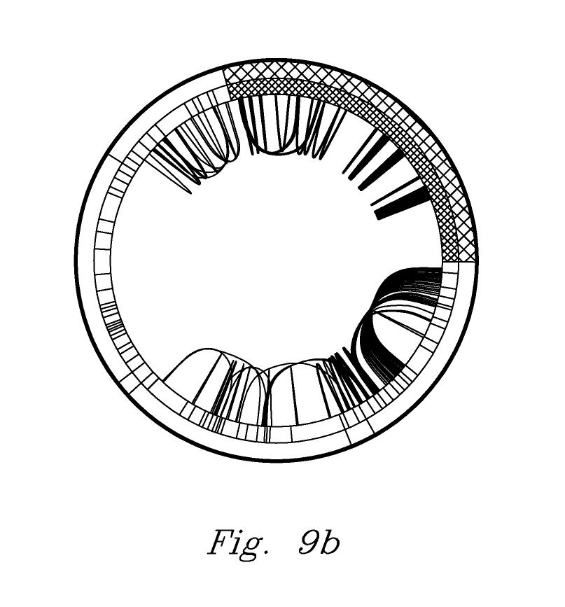

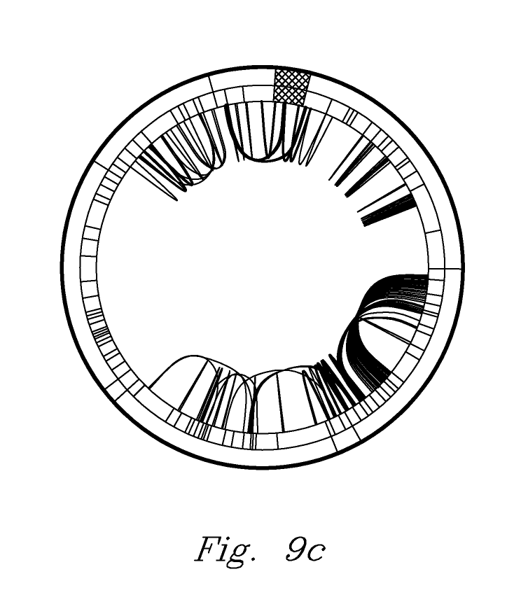

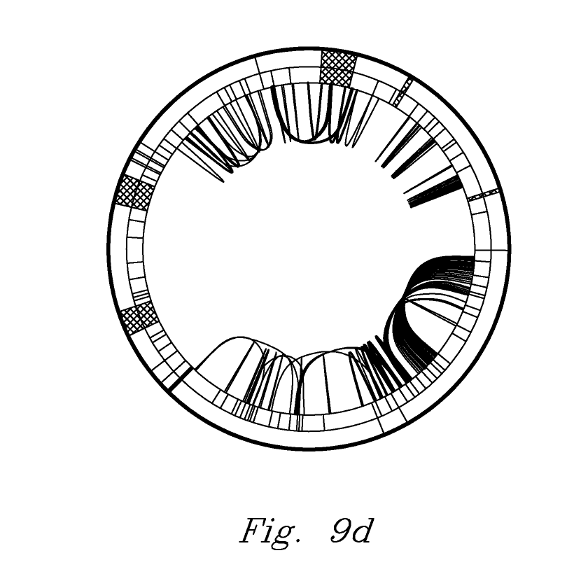

Referring to the embodiments depicted in FIGS. 9a-9d, selections of objects in the visual representation can be made using an input device. FIG. 9a depicts a visual node with no selections. FIGS. 9b-9d depict a visual node with an outer-circle arc selected, an inner-circle arc selected, and multiple arcs selected, respectively. Preferably, the selections are global and can distinguish what has been selected across other views. For example, any portion that is “selected” will be displayed in distinct manner (i.e., highlighting, coloring, sizing, etc.). If an element that is selected is smaller than can be displayed, it can be scaled to a larger size. Each portion of the visual representation described herein represents an abstraction of imported documents and/or its extracted elements. As such, clicking with an input device on any of the portions can select the represented documents and/or extracted elements and present them in a preview pane.

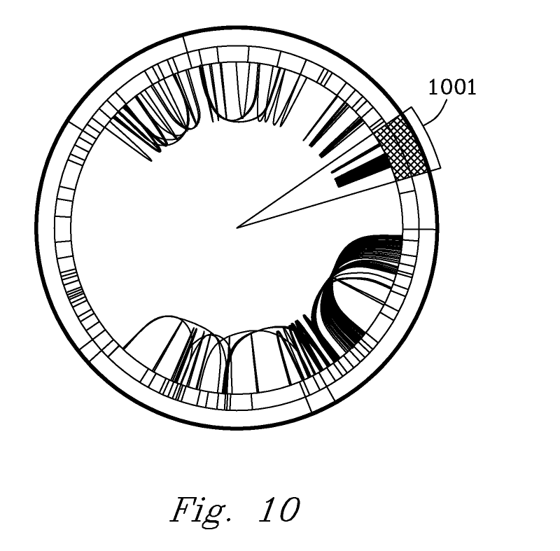

Custom selections can be made by selecting a subset of an arc or by selecting across multiple arcs. A subset of an arc can be selected as depicted in FIG. 10 by using a radial selection tool 1001. The radial selection tool works similar to the traditional square marquee tool used in most software except it pivots around the center of the visual node from which the custom selection is to be made.

While a number of embodiments of the present invention have been shown and described, it will be apparent to those skilled in the art that many changes and modifications may be made without departing from the invention in its broader aspects. The appended claims, therefore, are intended to cover all such changes and modifications as they fall within the true spirit and scope of the invention.

We claim:

1. A system comprising memory circuitry to store a corpus of data and processing circuitry to generate on a display device a visual representation of the data, of elements extracted from the data, and/or of categories of the data arranged according to an abstraction hierarchy defined according to an abstraction basis, the visual representation characterized by:
at least one visual node comprising an outer circle and an inner circle, the outer circle representing a parent level of the abstraction hierarchy and having arcs representing abstraction hierarchy nodes in the parent level, the inner circle representing a child level of the abstraction hierarchy and having arcs representing abstraction hierarchy nodes in the child level, wherein inner-circle arcs encompassed by a sector defined in part by an outer-circle arc represent child abstraction hierarchy nodes abstracted under a parent abstraction hierarchy node represented by the outer-circle arc.

2. The system of claim 1, further comprising at least one chord connecting two inner-circle arcs representing two particular abstraction hierarchy nodes, the chord representing a relationship between the two particular abstraction hierarchy nodes, the relationship defined by pre-determined criteria.

3. The system of claim 1, further comprising an input device and abstraction hierarchy definitions, wherein the abstraction basis comprises the abstraction hierarchy definitions provided by a user through the input device.

4. The system of claim 1, wherein the abstraction basis comprises at least one abstraction hierarchy rule stored on memory circuitry.

5. The system of claim 1, wherein the data comprise video, audio, images, text, or combinations thereof.

6. The system of claim 1, wherein the visual representation is further characterized by a link between a first visual node and a second visual node, outer circle arcs in the second visual node correspond to inner-circle arcs within a sector of the first visual node.

7. The system of claim 6, wherein the link further comprises lines representing relationships between arcs in the inner circle of the first visual node and arcs in the inner circle of the second visual node.

8. The system of claim 1, wherein the abstraction basis in one visual node differs from that in another visual node.

9. The system of claim 1, wherein the abstraction basis in the outer circle differs from that in the inner circle.

10. A method of displaying on a display device a visual representation of data stored on memory circuitry, of elements extracted from the data, and/or of categories of the data, the visual representation arranged according to an abstraction hierarchy defined according to an abstraction basis, the method characterized by the steps of:
Generating at least one visual node comprising an outer circle and an inner circle;
representing a parent level of the abstraction hierarchy by the outer circle and representing abstraction hierarchy nodes in the parent level by arcs in the outer circle;
representing a child level of the abstraction hierarchy by the inner circle and representing abstraction hierarchy nodes in the child level by arcs in the inner circle; and
encompassing inner-circle arcs by a sector defined in part by an outer-circle arc, the inner-circle arcs encompassed by the sector represent child abstraction hierarchy nodes abstracted under a parent abstraction hierarchy node represented by the outer-circle arc.

11. The method of claim 10, further comprising connecting two inner-circle arcs representing two particular abstraction hierarchy nodes with a chord, the chord representing the relationship between the two particular abstraction hierarchy nodes, the relationship defined by pre-determined criteria.

12. The method of claim 10, further comprising defining the abstraction basis at least in part according to abstraction hierarchy definitions provided by a user through an input device.

13. The method of claim 10, further comprising defining the abstraction basis at least in part by at least one abstraction hierarchy rule stored on memory circuitry.

14. The method of claim 10, wherein the data comprise video, audio, images, text, or combinations thereof.

15. The method of claim 10, further comprising linking a first visual node and a second visual node, the outer circle arcs in the second visual node correspond to inner-circle arcs within a sector of the first visual node.

16. The method of claim 15, wherein said linking further comprises generating lines representing relationships between arcs in the inner circle of the first visual node and arcs in the inner circle of the second visual node.

17. The method of claim 10, further comprising defining the abstraction basis in one visual node differently than that of another visual node.

18. The method of claim 10, further comprising defining the abstraction basis in the outer circle differently than that of the inner circle.
